(19) United States
(12) Patent Application Publication
(10) Pub. No.: US 2024/0039067 A1
(43) Pub. Date: Feb. 1, 2024

(54) TREATMENT METHOD FOR POSITIVE ELECTRODE OF NON-AQUEOUS ELECTROLYTE SECONDARY BATTERY

(71) Applicants: JAPAN METALS & CHEMICALS CO., LTD., Tokyo (JP); HONDA MOTOR CO., LTD., Tokyo (JP)

(72) Inventors: Yutaro KIKUCHI, Tokyo (JP); Atsushi YOKOYAMA, Tokyo (JP); Shinichi OGURA, Tokyo (JP); Yohei TAKANO, Tokyo (JP); Hideki HASHIMOTO, Tokyo (JP); Kenji HAYASHI, Tokyo (JP)

(21) Appl. No.: 18/021,380

(22) PCT Filed: Jul. 28, 2021
(86) PCT No.: PCT/JP2021/027851

§ 371 Date: Feb. 14, 2023

(30) Foreign Application Priority Data
Aug. 24, 2020 (JP) 2020-140948

(51) Int. Cl. H01M 10/54; C22B 7/00; C22B 5/02; C22B 21/00; C22B 21/02

(52) U.S. Cl. CPC H01M 10/54; C22B 7/001; C22B 5/02; C22B 21/0069; C22B 21/0092; C22B 21/02

(57) ABSTRACT

The treating method for a positive electrode for a non-aqueous electrolyte secondary battery is a treating method for a positive electrode for a non-aqueous electrolyte secondary battery which comprises a positive electrode having a foil containing Al and an active material which is a metal composite oxide, the method comprising: conducting a heating treatment for heating the positive electrode (heating step); melting the positive electrode using heat of reaction of the foil and the active material to obtain a molten material (melting step); and separating the molten material into a metal material containing a metal constituting the metal composite oxide and a slag (separating step). By subjecting the positive electrode to heating treatment, a reduction reaction of the positive electrode can be promoted at a low cost.

### TECHNICAL FIELD

The present invention relates to a treating method for a non-aqueous electrolyte secondary battery.

### BACKGROUND ART

Non-aqueous electrolyte secondary batteries, such as a lithium-ion secondary battery, are used as a power source mounted on a hybrid vehicle or electric vehicle. In recent years, a sharp increase of the amount of used non-aqueous electrolyte secondary batteries for automobile is expected. An electrode, particularly a positive electrode of a non-aqueous electrolyte secondary battery contains valuable materials including nickel (Ni) and cobalt (Co). For achieving effective utilization of resources, a method for recovering valuable materials, such as Ni and Co, from non-aqueous electrolyte secondary batteries has been proposed.

For example, PTL 1 has a description of a method for recovering cobalt from secondary battery waste, wherein the battery waste is subjected to roasting at 600° C. or higher, and then subjected to cutting, sifting, magnetic separation, and acid fusion, recovering cobalt.

PTL 2 has a description about a method in which a reducing agent is mixed into recovered materials containing Ni and Co obtained from a secondary battery and the resultant mixture is heated to recover valuable materials, such as Ni and Co.

### CITATION LIST

### Patent Literature

PTL 1: JPH10-46266A

PTL 2: JP2019-131871A

### SUMMARY OF INVENTION

### Technical Problem

The recovering method described in PTL 1 requires the steps for magnetic separation, acid fusion, and the like after roasting, and hence has a disadvantage of an increase of the cost for recycling. The recovering method described in PTL 2 needs the step for mixing a reducing agent, and poses a problem in that the operation for mixing and cost for the reducing agent are inevitably required. Furthermore, the step for forming a mixture of the recovered materials and reducing agent into a briquet is required for improving the reaction efficiency.

There is a “thermit method” as one of the methods for recovering a metal containing a valuable material from a positive electrode active material composed of a metal composite oxide. In the thermit method, a raw material in the form of a powder is generally used, and, before subjecting the positive electrode metal foil to thermit method, the step for pulverizing the metal foil is needed. When the positive electrode metal foil as such, which is not pulverized, is permitted to undergo a thermit reaction, external heating at high temperatures using a high-frequency induction melting furnace or the like is required, leading to an obstacle to reducing the cost.

Accordingly, an object of the present invention is to provide a treating method for a positive electrode for a non-aqueous electrolyte secondary battery, which can promote a reduction reaction of the positive electrode at a low cost.

### Solution to Problem

The treating method for a positive electrode for a non-aqueous electrolyte secondary battery of the present invention is a treating method for a positive electrode for a non-aqueous electrolyte secondary battery which comprises a positive electrode having a foil containing Al and an active material which is a metal composite oxide, wherein the method comprises: conducting a heating treatment for heating the positive electrode; melting the positive electrode using heat of reaction of the foil and the active material to obtain a molten material; and separating the molten material into a metal material containing a metal constituting the metal composite oxide and a slag.

### Advantageous Effects of Invention

In the present invention, by subjecting a positive electrode to heating treatment, a reduction reaction of the positive electrode active material can be promoted at a low cost.

### BRIEF DESCRIPTION OF DRAWINGS

FIG. 1 is a perspective view of a non-aqueous electrolyte secondary battery used in a treating method for a non-aqueous electrolyte secondary battery according to the present embodiment.

FIG. 2 is a flowchart for explaining the treating method for a non-aqueous electrolyte secondary battery according to the present embodiment.

### DESCRIPTION OF EMBODIMENTS

### 1. Embodiments

Hereinbelow, an embodiment of the present invention will be described in detail with reference to the drawings.

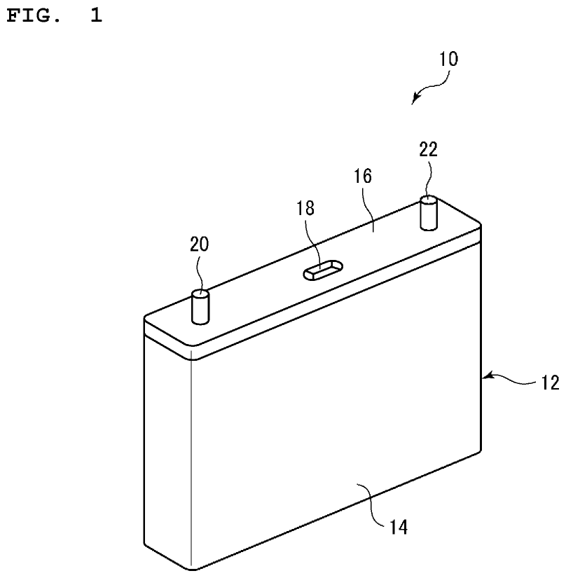

FIG. 1 is a perspective view of a non-aqueous electrolyte secondary battery 10 which is used in a treating method for a non-aqueous electrolyte secondary battery of the present embodiment. The non-aqueous electrolyte secondary battery 10 is a used lithium-ion secondary battery which has been used as a power source for automobile, such as an electric vehicle or a hybrid vehicle. In the following description, an explanation is made on the case where the non-aqueous electrolyte secondary battery 10 is a lithium-ion secondary battery as an example, but the non-aqueous electrolyte secondary battery 10 is not limited to a lithium-ion secondary battery, and may be a magnesium-ion secondary battery, a sodium-ion secondary battery, a potassium-ion secondary battery, a calcium-ion secondary battery, or the like. The non-aqueous electrolyte secondary battery 10 may be one which is unused, e.g., a lithium-ion secondary battery which has been found to be defective after produced. Alternatively, process scrap or the like generated in a production process for the non-aqueous electrolyte secondary battery may be used.

The non-aqueous electrolyte secondary battery 10 has an electrode assembly (not shown) and a non-aqueous electrolytic solution (not shown) in a cell case 12. The cell case 12 is, for example, made of an aluminum alloy. The cell case 12 has a case body 14 and a cover 16. The case body 14 and the cover 16 are laser-welded. The case body 14 is formed into a closed-end parallelepiped shape, and has the electrode assembly and the non-aqueous electrolytic solution contained therein. The cover 16 is placed in an opening of the case body 14 to seal the case body 14. The cover 16 is provided with a safety vent 18, a positive electrode terminal 20, and a negative electrode terminal 22. The safety vent 18 is aimed for lowering the pressure in the non-aqueous electrolyte secondary battery 10. The positive electrode terminal 20 is connected to a below-mentioned positive electrode through a positive electrode lead (not shown). The negative electrode terminal 22 is connected to a below-mentioned negative electrode through a negative electrode lead (not shown).

The electrode assembly has the positive electrode (not shown) and the negative electrode (not shown) which are spirally wound through a separator (not shown). The electrode assembly is not limited to one of the above-mentioned spirally wound type, but may be of a stacked type such that a positive electrode, a negative electrode, and a separator are stacked on one another.

The positive electrode has a positive electrode current collector and a positive electrode active material layer. The positive electrode current collector is a foil containing aluminum (Al) (hereinafter, referred to also as “Al foil”). The mass ratio of the positive electrode current collector in the positive electrode is 5 to 25% by mass. The positive electrode active material layer has a positive electrode active material, a binder, and a conductive material. The respective mass ratios of the conductive material and the binder in the positive electrode active material layer are 0 to 30% by mass and 0 to 20% by mass, based on the mass of the positive electrode.

As the positive electrode active material, an arbitrary metal composite oxide containing nickel (Ni) and/or cobalt (Co) can be used. For example, the positive electrode active material can be selected from a lithium-nickel composite oxide, a lithium-cobalt composite oxide, a lithium-nickel-cobalt composite oxide, a lithium-nickel-manganese composite oxide, a lithium-nickel-cobalt-aluminum composite oxide, a lithium-nickel-cobalt-manganese composite oxide, and the like. In the present embodiment, the positive electrode active material is a lithium-nickel-cobalt-manganese composite oxide. With respect to the positive electrode active material, an arbitrary magnesium composite oxide can be used in the case of a magnesium-ion secondary battery, an arbitrary sodium composite oxide can be used in the case of a sodium-ion secondary battery, an arbitrary potassium composite oxide can be used in the case of a potassium-ion secondary battery, and an arbitrary calcium composite oxide can be used in the case of a calcium-ion secondary battery.

The binder is a fluorine binder containing a fluorine compound, such as polyvinylidene fluoride (PVDF). The conductive material is a carbon material, such as graphite or carbon black.

The negative electrode has a negative electrode current collector and a negative electrode active material layer. For example, the negative electrode current collector is a copper (Cu) foil, and the negative electrode active material is graphite. As the separator, generally, a porous membrane or nonwoven fabric made of a resin, such as polyethylene (PE) or polypropylene (PP), is used.

The non-aqueous electrolytic solution contains a non-aqueous solvent and a lithium. salt (electrolyte) soluble in the non-aqueous solvent. As the non-aqueous solvent, a carbonate, for example, propylene carbonate (PC), ethylene carbonate (EC), butylene carbonate (BC), dimethyl carbonate (DMC), ethylmethyl carbonate (EMC), or diethyl carbonate (DEC) is used. These non-aqueous solvents can be used individually or in combination.

As the electrolyte, one which contains a fluorine compound, for example, LiPF₆ (lithium hexafluorophosphate), LiBF₄ (lithium tetrafluoroborate), LiTFSA (lithium trifluoromethanesulfonylamide), or LiTFSI (lithium bis(trifluoromethane)sulfoneimide) is used. These electrolytes can be used individually or in combination.

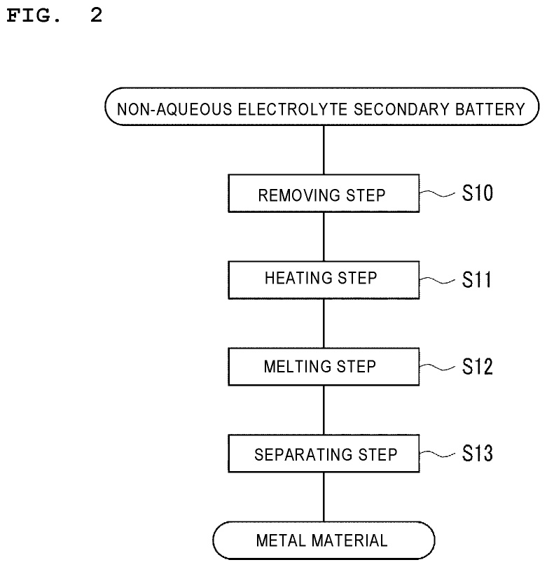

As shown in FIG. 2, the treating method for the non-aqueous electrolyte secondary battery 10 is a treating method for a non-aqueous electrolyte secondary battery which comprises a positive electrode having a foil containing Al and an active material which is a metal composite oxide, wherein the method comprises the steps of: removing the positive electrode from the non-aqueous electrolyte secondary battery 10 (removing step S10); conducting a heating treatment for heating the positive electrode (heating step S11); melting the positive electrode using heat of reaction of the foil and the active material to obtain a molten material (melting step S12); and separating the molten material into a metal material containing a metal constituting the metal composite oxide and a slag (separating step S13). The expression “reaction of the foil and the active material” means an oxidation-reduction reaction in which when a mixture of the positive electrode current collector which is metallic Al and the positive electrode active material which is a metal oxide is subjected to reaction, heat at a high temperature is generated while reducing the metal oxide by metallic Al, and this reaction is also referred to as “thermit reaction”. The positive electrode undergoes spontaneous heat generation using heat of reaction of the foil and the active material. The term “spontaneous heat generation” means that the positive electrode itself is increased in temperature using heat of reaction of the foil and the active material without applying heat energy to the positive electrode from an external heating means (for example, a high-frequency induction melting furnace). The individual steps are described below in detail.

### [Removing Step]

In the removing step S10, the cell case 12 is opened and the spirally wound electrode assembly is removed from the container and unwound to obtain a positive electrode in a sheet form. The sheet-form positive electrode is subjected to the heating step S11 and the melting step S12. In the removing step S10, the step of discharging the non-aqueous electrolyte secondary battery 10 (discharging step), the step of cleaning the inside of the cell case 12 of the discharged non-aqueous electrolyte secondary battery 10 with a cleaning fluid (cell interior cleaning step), or the like may be conducted.

### [Heating Step]

In the heating step S11, the sheet-form positive electrode obtained in the removing step S10 is subjected to heating treatment. The positive electrode which has been subjected to the heating treatment is subjected to the melting step S12 which is the subsequent step. The heating treatment promotes the thermit reaction in the melting step S12, so that the positive electrode is melted, making it possible to reduce the active material.

The heating treatment is described. A heating apparatus used in the heating treatment has a heating oven, a heater, a thermometer, a gas supply unit, a flowmeter, and a controller. The heating oven has an internal space for having the positive electrode contained therein. The heater heats the positive electrode placed in the heating oven. The thermometer measures a temperature in the heating oven. The gas supply unit feeds a gas containing oxygen (air in this example) into the heating oven to create an atmosphere containing oxygen in the heating oven. The flowmeter measures a flow rate of air in the heating oven. The controller controls the heater based on the results of measurement made by the thermometer to increase the temperature in the heating oven to a preset heating temperature at a predetermined increase rate. The controller controls the gas supply unit based on the results of measurement made by the flowmeter to control the flow rate of the air fed into the heating oven. The controller controls the heater and the gas supply unit so that the heating temperature and the flow rate are maintained for a predetermined period of time. A period of time during which the heating temperature and the flow rate are maintained is referred to as “keeping time”. The above-described heating apparatus is an example. Therefore, the construction of the heating apparatus is not limited to the construction described above but can be appropriately designed.

The procedure for the heating treatment is described. The sheet-form positive electrode is first placed in a heat-resistant container. Then, the heating apparatus is operated, and the temperature in the heating oven is increased to a preset heating temperature. The container having the positive electrode placed therein is set in the heating oven, and air is fed into the heating oven at a predetermined flow rate. The heating temperature and the flow rate are maintained until a preset keeping time has lapsed. The container having the positive electrode placed therein may be set in the heating oven before operating the heating apparatus.

With respect to the heating treatment, it is preferred that heating is conducted at a temperature at which the foil is not powdered. When the heating temperature is too high, the Al foil as a positive electrode current collector becomes brittle. Such a brittle foil crumbles into powdered pieces only by, for example, gently touching it with fingers, forming a powder of the foil. The positive electrode active material in this state is peeled off the foil, forming a powder of the active material. Thus, when the heating temperature is too high, the positive electrode is in the form of a powder which contains a powder of the foil and a powder of the active material. When the Al foil is powdered, the Al foil and the positive electrode active material are in the state in which they are separated and do not adhere to each other, as compared to those in the case where the Al foil is not powdered, and therefore the thermit reaction in the melting step S12, i.e., the reaction using heat of reaction of the foil and the active material is inhibited. When the Al foil becomes brittle, it is considered that part of the Al foil is oxidized to form alumina. In this case, Al which serves as a reducing agent is reduced. Further, when alumina is formed so as to cover the surface of the Al foil, the active material and Al are prevented from being in contact, inhibiting the reaction. By conducting the heating treatment at a temperature at which the foil is not powdered, oxidation of the Al foil can be suppressed, and the Al foil is prevented from being powdered, and therefore the positive electrode having maintained the state in which the Al foil and the positive electrode active material adhere to each other can be subjected to the melting step S12.

It is preferred that the heating treatment is conducted at a temperature at which the binder is decomposed. When the heating temperature is too low, decomposition of the binder is unsatisfactory, so that the binder remains in the positive electrode. When the positive electrode in which the binder remains is subjected to the melting step S12, the binder undergoes thermal decomposition and then oxidation in the melting step S12 to generate a gas of an oxide of hydrogen or carbon, such as H₂O, CO₂, or CO, inhibiting the thermit reaction. The gas which inhibits the thermit reaction is referred to as “reaction inhibitor gas”. By conducting the heating treatment at a temperature at which the binder is decomposed, the positive electrode having the binder removed therefrom can be subjected to the melting step S12. It is more preferred that the heating treatment is conducted at a temperature at which the conductive material is removed by oxidation.

With respect to the heating treatment, it is preferred that heating is conducted at 400° C. to 650° C. When the heating temperature is 400° C. to 650° C., the binder is surely decomposed, and further the Al foil is not powdered and the state in which the Al foil and the positive electrode active material adhere to each other is surely maintained. When the heating treatment for the positive electrode is conducted at a heating temperature of 660° C. which is the melting point of aluminum or higher, it is considered that the Al foil is fused and the surface of the fused aluminum is oxidized, so that the Al foil becomes brittle and is powdered. When the heating temperature is too high, alumina is formed between the metallic Al and the active material, so that the portion at which the Al foil and the positive electrode active material adhere to each other is reduced, inhibiting the thermit reaction. Further, when the heating temperature is too high, there is a danger that Al in the positive electrode current collector serves as a reducing agent to cause an unintended thermit reaction. With respect to the heating treatment, it is especially preferred that heating is conducted at 450° C. to 600° C.

The positive electrode to be subjected to the heating treatment may be in a sheet form as mentioned above, or may be in a strip form obtained by cutting using, for example, a shredder.

A combustion improver may be mixed into the positive electrode which has been subjected to the heating step S11, and the positive electrode having the combustion improver mixed may be subjected to the melting step S12 which is the next step. As a combustion improver, for example, a powder containing Al and NaClO₃ (sodium chlorate) is used. By mixing a combustion improver into the positive electrode, combustion of the positive electrode is promoted in the melting step S12, making it possible to further promote the thermit reaction.

### [Melting Step]

In the melting step S12, the positive electrode heated by the heating treatment is melted. With respect to the melting step S12, an example in which LiNiₓCo_{y}Mn_{z}O₂ is used as the positive electrode active material is described. In the melting step S12, the Al foil contained in the positive electrode serves as a reducing agent, so that the reaction shown below is caused. As a result of the reaction, an alloy (NiₓCo_{y}Mn_{z}) containing Ni, Co, and Mn is obtained as a metal material containing a metal constituting the metal composite oxide.

LiNiₓCo_{y}Mn_{z}O₂+Al→½Li₂O+NiₓCo_{y}Mn_{z}+½Al₂O₃

The thermit reaction is a reaction accompanied by vigorous heat generation and hence, after the temperature has reached a temperature at which the reaction continues, the reaction proceeds due to spontaneous heat generation (heat of reaction). As a method for exciting the thermit reaction, for example, there is a thermit method in which the positive electrode is placed in a crucible and ignited. Basically, only the ignition causes the thermit reaction to proceed, so that a metal material containing a metal constituting the metal composite oxide can be obtained. In the thermit method, if necessary, an appropriate combustion improver can be used. Further, there is a method using an apparatus for applying heat at high temperatures from the outside, such as an arc melting or high-frequency induction melting furnace, and, in this method, the positive electrode is melted due to spontaneous heat generation (heat of reaction), and further the positive electrode is melted also due to heat of an arc melting or high-frequency induction melting furnace or the like.

### [Separating Step]

In the separating step S13, by cooling the molten material, the molten material is separated into a metal material containing a metal constituting the metal composite oxide and a slag.

### 2. Effects

In the treating method for a non-aqueous electrolyte secondary battery of the present embodiment, the method has the heating step S11 before the melting step S12, and therefore a spontaneous oxidation-reduction reaction (thermit reaction) proceeds in the melting step S12, so that a reduction reaction of the positive electrode can be promoted at a low cost.

The step for pulverizing the positive electrode and the step for separating the foil and the active material are not needed, and therefore not only can the yield in recycling the positive electrode be improved, but also the cost is reduced.

By conducting heating at a temperature at which the foil is not powdered in the heating step S11, the state in which the Al foil and the positive electrode active material adhere to each other is maintained, so that the thermit reaction in the melting step S12 is promoted.

By conducting heating at a temperature at which the binder is decomposed in the heating step S11, generation of a reaction inhibitor gas at the stage of the melting step S12 is suppressed, so that the thermit reaction is promoted.

By conducting heating at 400° C. to 650° C. in the heating step S11, an occurrence of a thermit reaction during the heating treatment is suppressed, improving the safety. Further, the Al foil is not powdered, and the state in which the Al foil and the positive electrode active material adhere to each other is maintained. By the heating treatment, the binder is removed, so that generation of a reaction inhibitor gas at the stage of the melting step S12 is suppressed. As a result, the thermit reaction in the melting step S12 is promoted.

### 3. Examples

Hereinbelow, experiments conducted for checking the effects of the present invention will be described.

### Example 1 to Example 4

A used non-aqueous electrolyte secondary battery having a spirally wound electrode assembly and a non-aqueous electrolytic solution contained in the cell case 12 was prepared. The constituents of the positive electrode and the non-aqueous electrolytic solution contained in the prepared non-aqueous electrolyte secondary battery are as follows.

### <Positive Electrode>

| Al Foil | thickness: 15 μm, 20% | by mass |
|---|---|---|
| Active material (LiNi₁/₆CO₂/₃Mn₁/₆O₂) | 72 to 73% | by mass |
| Binder (PVDF) | 3 to 4% | by mass |
| Conductive material | 4% | by mass |

| | |
|---|---|
| <Non-aqueous electrolytic solution> | |
| Non-aqueous solvent (DMC:EMC:PC) | mass ratio: 28:27:28 |
| Electrolyte (LiPF₆) | 1M |

In the experiments, the prepared non-aqueous electrolyte secondary battery was first discharged, and the cell case 12 was opened and the spirally wound electrode assembly was removed from the container and unwound to obtain the positive electrode (removing step S10). Then, experiments were conducted by successively subjecting the obtained positive electrode to the heating step S11 and the melting step S12. The conditions for experiments and the results of evaluation are shown in Table 1.

The positive electrode which was subjected to heating treatment in the heating step S11 corresponded to Examples 1 to 4. In Examples 1 to 4, the heating temperature was changed in the range of from 400° C. to 600° C. and the respective positive electrodes in the Examples were obtained. In Examples 1 to 3, the positive electrode in the state of a foil was subjected to heating treatment, and, after the heating treatment, the state of a foil was maintained. In Example 4, the positive electrode in the state of a foil was subjected to heating treatment, and, after the heating treatment, both the positive electrode in the state of a foil and the one in the state of a powder were present. In Table 1, the column for “Temperature [° C]” indicates a heating temperature in the heating treatment. In the column for “Temperature [° C]” and the column for “Form of positive electrode after heating treatment”, “−” means that the heating treatment was not conducted.

In the melting step S12, the positive electrode in each of Examples 1 to 4 was placed in a crucible and ignited. No combustion improver was used.

The molten material obtained in the melting step S12 was removed from the crucible, and visual observation was made to check whether the positive electrode was melted, and the thermit reaction was evaluated in accordance with the following criteria. The ratings “⊙” and “◯” indicate acceptable, and the rating “X” indicates unacceptable.

“⊙”: The positive electrode was melted, and a metal material was obtained and a thermit reaction occurred.

“◯”: Part of the positive electrode was melted, and a metal material was obtained and a thermit reaction occurred. “X”: No metal material was obtained, and no thermit reaction occurred.

TABLE 1

| | | Form of positive | |
|---|---|---|---|
| | Temperature | electrode after | Thermit |
| | [° C.] | heating treatment | reaction |
| Example 1 | 400 | Foil | ◯ |
| Example 2 | 450 | Foil | ⊚ |
| Example 3 | 500 | Foil | ⊚ |
| Example 4 | 600 | Foil and powder | ◯ |
| Comparative | — | — | X |
| Example 1 | | | |
| Comparative | 750 | Powder | X |
| Example 2 | | | |

### Comparative Example 1 and Comparative Example 2

The sheet-form positive electrode which was not subjected to the heating step S11 corresponded to Comparative Example 1. The positive electrode, which was subjected to heating treatment under substantially the same conditions as in Examples 1 to 4 except that the heating temperature was changed, corresponded to Comparative Example 2. With respect to Comparative Examples 1 and 2, evaluation was made in accordance with the same method and criteria as those in Examples 1 to 4.

A comparison is made between Examples 1 to 4 corresponding to the positive electrode which was subjected to the heating step S11 and Comparative Example 1 corresponding to the positive electrode which was not subjected to the heating step S11. From Table 1, it is apparent that, in Comparative Example 1, no thermit reaction occurred and a metal material was not obtained, whereas, in Examples 1 to 4, a metal material was obtained due to a thermit reaction. From the above, it has been found that the thermit reaction is promoted by conducting the heating step S11.

A comparison is made between Examples 1 to 4 corresponding to the positive electrode which was subjected to heating treatment at a heating temperature in the range of from 400° C. to 600° C. and Comparative Example 2 corresponding to the positive electrode which was subjected to heating treatment at a heating temperature of 750° C. From the comparison, it is apparent that, in Comparative Example 2, after the heating treatment, the Al foil was powdered and the thermit reaction was inhibited, and a metal material was not obtained, whereas, in Examples 1 to 4, a metal material was obtained due to a thermit reaction. From the above, it has been found that when the heating temperature is in the range of from 400° C. to 600° C., the Al foil is not powdered and the state in which the Al foil and the positive electrode active material adhere to each other is maintained, so that a thermit reaction is promoted. Further, when the heating temperature is in the range of from higher than 600° C. to 650° C., which is lower than 660° C. that is the melting point of aluminum, it is considered that the Al foil is not powdered and the state in which the Al foil and the positive electrode active material adhere to each other is maintained, so that the thermit reaction is promoted as in Examples 1 to 4.

From a comparison between Examples 1 to 4, it is apparent that the thermit reaction in Examples 2 and 3, in which the heating temperature is in the range of from 450° C. to 500° C., is more excellent than that in Example 1 in which the heating temperature is 400° C. and Example 4 in which the heating temperature is 600° C. From the above, it has been found that the heating temperature is especially preferably in the range of from 450° C. to 500° C.

In Examples 1 to 4 and Comparative Examples 1 and 2, no combustion improver is used in the melting step S12. In other words, in the present invention, as can be seen from Table 1, even when using no combustion improver, a metal material containing a metal constituting the metal composite oxide can be obtained from the molten material obtained in the melting step S12.

The present invention is not limited to the above-mentioned embodiments, and can be appropriately changed or modified as long as the method of the present invention can be achieved.

### Additional Notes

### (Additional Item 1)

A treating method for a non-aqueous electrolyte secondary battery which comprises a positive electrode having a foil containing Al and an active material which is a metal composite oxide, the method comprising:

conducting a heating treatment for heating the positive electrode;

melting the positive electrode using heat of reaction of the foil and the active material to obtain a molten material; and

separating the molten material into a metal material containing a metal constituting the metal composite oxide and a slag.

### (Additional Item 2)

The treating method for a non-aqueous electrolyte secondary battery according to Additional item 1 above, wherein, in the heating treatment, heating is conducted at a temperature at which the foil is not powdered.

### (Additional Item 3)

The treating method for a non-aqueous electrolyte secondary battery according to Additional item 1 or 2 above, wherein the positive electrode comprises a binder, wherein, in the heating treatment, heating is conducted at a temperature at which the binder is decomposed.

### (Additional Item 4)

The treating method for a non-aqueous electrolyte secondary battery according to Additional item 3 above, wherein, in the heating treatment, heating is conducted at 400° C. to 650° C.

### (Additional Item 5)

A treating method for a positive electrode for a non-aqueous electrolyte secondary battery which comprises a positive electrode having a foil containing Al and an active material which is a metal composite oxide, the method comprising:

conducting a heating treatment for heating the positive electrode;

melting the positive electrode using heat of reaction of the foil and the active material to obtain a molten material; and

separating the molten material into a metal material containing a metal constituting the metal composite oxide and a slag.

### (Additional Item 6)

The treating method for a positive electrode for a non-aqueous electrolyte secondary battery according to Additional item 5 above, wherein, in the heating treatment, heating is conducted at a temperature at which the foil is not powdered.

### (Additional Item 7)

The treating method for a positive electrode for a non-aqueous electrolyte secondary battery according to Additional item 5 or 6 above, wherein the positive electrode comprises a binder, wherein, in the heating treatment, heating is conducted at a temperature at which the binder is decomposed.

### (Additional Item 8)

The treating method for a positive electrode for a non-aqueous electrolyte secondary battery according to Additional item 7 above, wherein, in the heating treatment, heating is conducted at 400° C. to 650° C.

### (Additional Item 9)

The treating method for a positive electrode for a non-aqueous electrolyte secondary battery according to any one of Additional items 5 to 8 above, wherein the positive electrode is process scrap generated in a production process for the non-aqueous electrolyte secondary battery.

### (Additional Item 10)

The treating method for a positive electrode for a non-aqueous electrolyte secondary battery according to any one of Additional items 5 to 8 above, wherein the positive electrode is a positive electrode of an unused non-aqueous electrolyte secondary battery.

### (Additional Item 11)

The treating method for a positive electrode for a non-aqueous electrolyte secondary battery according to any one of Additional items 5 to 8 above, wherein the positive electrode is a positive electrode of a used non-aqueous electrolyte secondary battery.

### REFERENCE SIGN LIST

10: Non-aqueous electrolyte secondary battery
S11: Heating step
S12: Melting step
S13: Separating step

1. A treating method for a positive electrode for a non-aqueous electrolyte secondary battery which comprises a positive electrode having a foil containing Al and an active material which is a metal composite oxide, the method comprising:
conducting a heating treatment for heating the positive electrode;
melting the positive electrode using heat of reaction of the foil and the active material to obtain a molten material; and
separating the molten material into a metal material containing a metal constituting the metal composite oxide and a slag.

2. The treating method for a positive electrode for a non-aqueous electrolyte secondary battery according to claim 1, wherein, in the heating treatment, heating is conducted at a temperature at which the foil is not powdered.

3. The treating method for a positive electrode for a non-aqueous electrolyte secondary battery according to claim 1, wherein the positive electrode comprises a binder, wherein, in the heating treatment, heating is conducted at a temperature at which the binder is decomposed.

4. The treating method for a positive electrode for a non-aqueous electrolyte secondary battery according to claim 3, wherein, in the heating treatment, heating is conducted at 400° C. to 650° C.

5. The treating method for a positive electrode for a non-aqueous electrolyte secondary battery according to claim 1, wherein the positive electrode is process scrap generated in a production process for the non-aqueous electrolyte secondary battery.

6. The treating method for a positive electrode for a non-aqueous electrolyte secondary battery according to claim 1, wherein the positive electrode is a positive electrode of an unused non-aqueous electrolyte secondary battery.

7. The treating method for a positive electrode for a non-aqueous electrolyte secondary battery according to claim 1, wherein the positive electrode is a positive electrode of a used non-aqueous electrolyte secondary battery.

8. The treating method for a positive electrode for a non-aqueous electrolyte secondary battery according to claim 2, wherein the positive electrode comprises a binder, wherein, in the heating treatment, heating is conducted at a temperature at which the binder is decomposed.

9. The treating method for a positive electrode for a non-aqueous electrolyte secondary battery according to claim 2, wherein the positive electrode is process scrap generated in a production process for the non-aqueous electrolyte secondary battery.

10. The treating method for a positive electrode for a non-aqueous electrolyte secondary battery according to claim 2, wherein the positive electrode is a positive electrode of an unused non-aqueous electrolyte secondary battery.

11. The treating method for a positive electrode for a non-aqueous electrolyte secondary battery according to claim 2, wherein the positive electrode is a positive electrode of a used non-aqueous electrolyte secondary battery.

12. The treating method for a positive electrode for a non-aqueous electrolyte secondary battery according to claim 8, wherein, in the heating treatment, heating is conducted at 400° C. to 650° C.

13. The treating method for a positive electrode for a non-aqueous electrolyte secondary battery according to claim 8, wherein the positive electrode is process scrap generated in a production process for the non-aqueous electrolyte secondary battery.

14. The treating method for a positive electrode for a non-aqueous electrolyte secondary battery according to claim 8, wherein the positive electrode is a positive electrode of an unused non-aqueous electrolyte secondary battery.

15. The treating method for a positive electrode for a non-aqueous electrolyte secondary battery according to claim 8, wherein the positive electrode is a positive electrode of a used non-aqueous electrolyte secondary battery.

16. The treating method for a positive electrode for a non-aqueous electrolyte secondary battery according to claim 12, wherein the positive electrode is process scrap generated in a production process for the non-aqueous electrolyte secondary battery.

17. The treating method for a positive electrode for a non-aqueous electrolyte secondary battery according to claim 12, wherein the positive electrode is a positive electrode of an unused non-aqueous electrolyte secondary battery.

18. The treating method for a positive electrode for a non-aqueous electrolyte secondary battery according to claim 12, wherein the positive electrode is a positive electrode of a used non-aqueous electrolyte secondary battery.
